(19) United States
(12) Patent Application Publication
(10) Pub. No.: US 2021/0196058 A1
(43) Pub. Date: Jul. 1, 2021

(54) PRODUCT MERCHANDISING SYSTEMS WITH MODULAR PUCK ASSEMBLIES FOR MOUNTING AND DISPLAYING PRODUCTS

(71) Applicant: Mobile Tech, Inc., Hillsboro, OR (US)

(72) Inventors: Wade Wheeler, Hillsboro, OR (US); Robert Logan Blaser, Farmington, UT (US); Mitch Hose, Hillsboro, OR (US); Jacob Michael Collier, Syracuse, UT (US)

(73) Assignee: Mobile Tech, Inc., Hillsboro, OR (US)

(21) Appl. No.: 17/134,791

(22) Filed: Dec. 28, 2020

Related U.S. Application Data
(60) Provisional application No. 62/955,173, filed on Dec. 30, 2019.

(51) Int. Cl. A47F 7/024; H02J 50/10

(52) U.S. Cl. CPC A47F 7/024; H02J 50/10

(57) ABSTRACT

This disclosure is directed to product merchandising systems that enable products to be swapped between base assemblies of different product merchandising systems and accommodate different charging/powering capabilities of the products. Product merchandising systems have puck assemblies comprising modular puck upper portions and modular puck lower portions. Various different products may be mounted on the modular puck upper portions, each with a different way of receiving power from the modular puck upper portions. Each modular puck upper portion can be detached from a modular puck lower portion of a product merchandising system and reattached to a modular puck lower portion of another product merchandising system without having to reconfigure a power connection to the product attached to the modular puck upper portion.

### CROSS-REFERENCE TO RELATED APPLICATION

This application claims the benefit of Provisional Application No. 62/955,173, filed Dec. 30, 2019.

### TECHNICAL FIELD

The present disclosure is directed to secure product merchandising systems.

### BACKGROUND

Selling products in a retail setting is a balance between a seller's desire to create customer interest in products on display by allowing customers to inspect and handle the products and the seller's need to ensure that the products are not stolen. Retail sales of small electronic devices, such as cell phones, tablets, cameras, and wearable electronics, are often placed on display tables in large open retail settings, enabling customers an opportunity to inspect many different models by simply walking from table to table. However, because these products can be easily concealed and stolen in a crowded open retail setting, products are secured to display tables using merchandising systems that are constructed to prevent theft of the products on display. A typical merchandising system comprises a puck and a base secured to a display table or shelf. A product is attached to the puck and a tether connects the puck to a self-winding reel located within the base. When a customer lifts a product to examine the product's features, the product is held under tension by the self-winding reel. The merchandising system can also provide power to the product. For example, the base can receive power from an external power source and provide power to the puck via the tether, charge contacts or inductive power transfer, and a power cable can be used to provide power from the puck to the product.

Retailers often rearrange products on display tables when introducing new products or move products to different display tables to promote product sales. However, current product merchandising systems are not configured so that products can be easily detached from their bases or moved to other bases of product merchandising systems. For example, pucks holding two different products of separate product merchandising systems cannot be switched, especially for products configured to receive power in different ways from the attached pucks. Digital cameras with on-board rechargeable batteries are a particularly challenging product for switching between bases of conventional product merchandising systems. Certain digital cameras do not permit battery re-charging while the battery is contained within the camera. Other digital cameras have a standardized connector that permits on-board battery recharging and provides data connectivity to the camera. As a result, for retailers to rearrange or swap existing products for new ones, retailers must detach the entire product merchandising system from one display table and reattach it to another display table or detach the product from the puck of one product merchandising system and reattach the product to a puck of a different product merchandising system, which waste time and increases wear and tear on the product merchandising system, the display table, and on the products. Retailers seek product merchandising systems that can be used to display a variety of different kinds of products and allow products to be switched between bases of product merchandising systems.

### SUMMARY

This disclosure is directed to product merchandising systems that enable products to be swapped between base assemblies of different product merchandising systems and accommodate different charging powering capabilities of the products. Puck assemblies of two or more product merchandising systems each comprise a modular puck upper portion and a modular puck lower portion. A different product may be mounted on each of the modular puck upper portions. Each of the products may have different charging/power capabilities received via the modular puck upper portions. Each modular puck upper portion can be detached from a modular puck lower portion of a product merchandising system and reattach to a modular puck lower portion of another product merchandising system. Each of the modular puck lower portions houses electronics and power provisioning circuitry that can support the various charging/powering capabilities of the different products attached to the modular puck upper portions. As a result, each modular puck upper portion can be detached from a modular puck lower portion of a product merchandising system and reattached to a modular puck lower portion of another product merchandising system without having to reconfigure the power connection to the product attached to the modular puck upper portion.

### DESCRIPTION OF THE DRAWINGS

FIGS. 1A-1C show examples of product merchandising systems for merchandising products.

FIG. 2A shows examples of two modular product merchandising systems for displaying and merchandising different product.

FIG. 2B shows an exploded view of the two modular product merchandising systems FIG. 2A.

FIG. 3A shows top views of a modular puck upper portions.

FIGS. 3B-3C show elevation views of modular puck upper portions attached to modular puck lower portions.

FIG. 4A shows front views of a product merchandising systems with cameras attached to modular puck upper portions.

FIG. 4B shows back views of the product merchandising systems and cameras shown in FIG. 4A.

FIGS. 5A-5B show perspective views of a puck assembly with a modular puck upper portion detached from a modular puck lower portion.

FIGS. 6A-6F show an example sequence of steps for merchandising a camera via a product merchandising system.

FIG. 7 shows a secondary security cable used to secure an auxiliary component of a product to a modular puck lower portion.

FIG. 8 shows an example architecture of electrical components of a modular puck lower portion.

FIG. 9 shows an example of electrical components that can be included within a housing of a modular battery pack of a modular puck upper portion.

FIGS. 10A-10B are flow diagrams of methods for unlocking a puck assembly from a tether of a base assembly.

FIGS. 11A-11B are flow diagrams of methods for controlling charging of a battery of a product attached to a puck assembly.

### DETAILED DESCRIPTION

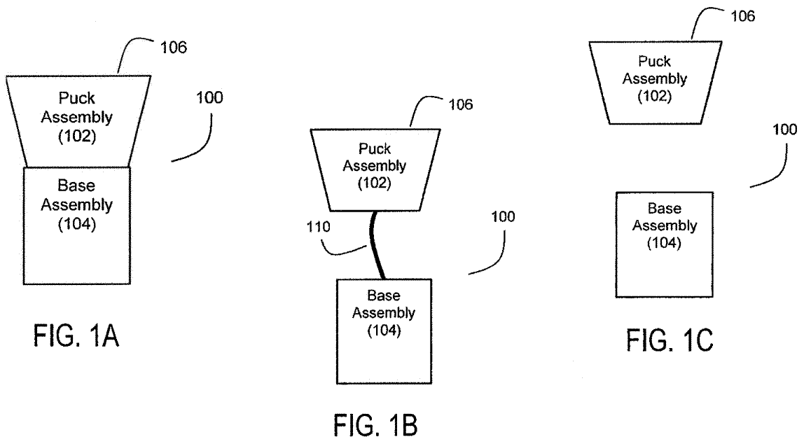

FIGS. 1A and 1B show an example of a product merchandising system 100 comprising a puck assembly 102 and a base assembly 104. The base assembly 104 can be secured to a display table or shelf. As shown in FIG. 1B, a tether 110 connects the puck assembly 102 with the base assembly 104. A product such as an electronic device can be mounted on a top or upper surface 106 of the puck assembly 102 so that the electronic device can be securely displayed to customers in a retail store. Examples of electronic devices include smart phones. tablet computers. cameras, wearables (e.g., smart watches), etc. The puck assembly 102 is moveable between a rest position and a lift position. When in the rest position, the puck assembly 102 contacts the base assembly 104 as shown in FIG. 1A. When in the lift position, the puck assembly 102 separates from the base assembly 104 as shown in FIG. 1B. FIG. 1B also shows the tether 110 remains connected to the puck assembly 102 and the base assembly 104 when the puck assembly 102 is in the lift position. The tether 110 allows for a customer to pick up, hold, and inspect the electronic device when making a purchase decision. To provide ease of handling, tether 110 may be a retractable tether that is included as part of a retractable tether assembly locate within the base assembly 104. In other implementations, the tether 110 is omitted to permit a wider range of customer handling for the merchandised product as shown in FIG. 1C.

The product merchandising system 100 can provide power to the product. For example, the base assembly 104 can receive power from an external power source and provision the power to the puck assembly 102 via the tether 110, charge contacts or inductive power transfer techniques. A power cable can be connected between connectors on the puck assembly 102 and a product attached to the upper surface 106 to deliver power from the puck assembly 102 to the product.

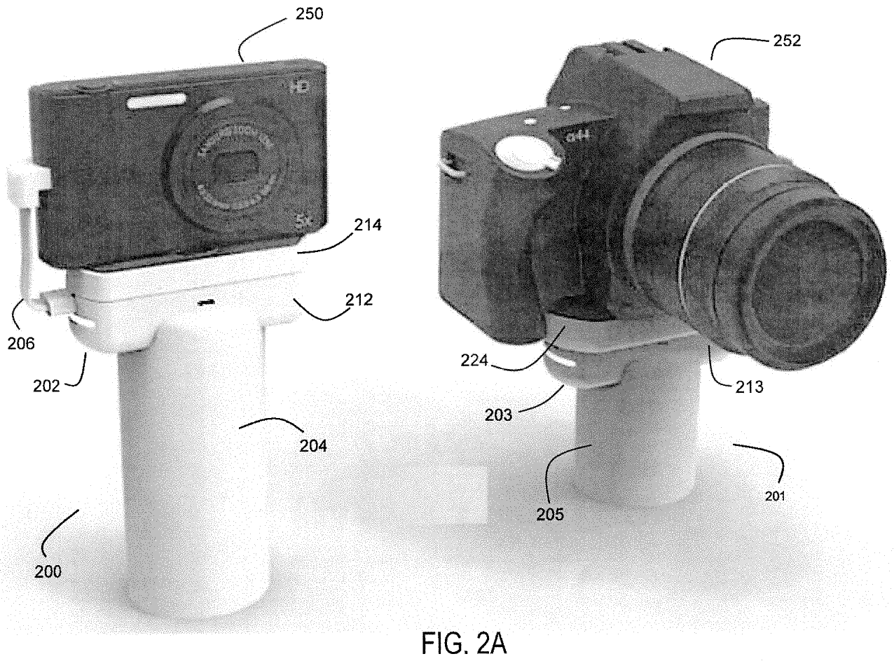

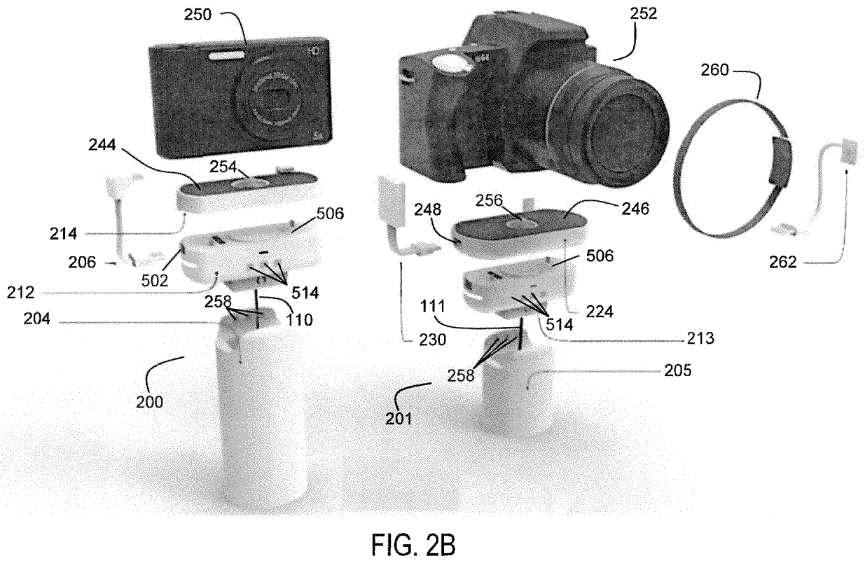

FIG. 2A shows examples of two modular product merchandising systems 200 and 201 for displaying and merchandising different product, such as two different cameras 250 and 252, respectively. The product merchandising systems 200 includes a puck assembly 202 and a base assembly 204. The product merchandising system 201 includes a puck assembly 203 and a base assembly 205. The puck assembly 202 includes modular puck lower portion 212 and a modular puck upper portion 214. The puck assembly 203 includes a modular puck lower portion 213 and a modular puck upper portion 224. The modular puck upper portions 214 and 224 may be formed from molded plastic and/or metal materials.

For a frame of reference in the discussions below with respect to various components of the product merchandising system 200, terms, such as “upper,” “top,” “higher,” and “upward,” and “lower”, “bottom”, and “downward,” are relative terms with respect to the vertical arrangement of components of the product merchandising systems 200 and 201. For example, the puck assembly 202 is top, higher, or upward with respect to the base assembly 204 and the base assembly 204 is lower, bottom, or downward with respect to the puck assembly 202. The term “length” refers to a vertical dimension from an upper portion to a lower portion, and the term “width” refer to a lateral dimension that is perpendicular to the length dimension. Similarly, “vertical” refers to a length dimension for a product merchandising system 200 and “horizontal” refers to a width dimension for the product merchandising system 200.

FIG. 2B shows an exploded view of the product merchandising systems 200 and 201 shown in FIG. 2A. FIG. 2B shows the modular puck lower portion 212 detached from the modular puck upper portion 214 and the modular puck lower portion 213 detached from the modular puck upper portion 224. The modular puck lower portions 212 and 213 are identical and serve as common platforms for the modular puck upper portions 214 and 224. With the modular puck upper portion 214 detached from the modular puck lower portion 212 and the modular puck upper portion 224 detached from the modular puck lower portion 213, the modular puck upper portion 214 can be swapped with the modular puck upper portion 224. In other words, camera 252 and connected modular puck upper portion 224 can be placed on the modular puck lower portion 212 and camera 252 and connected modular puck upper portion 224 can be placed on the modular puck lower portion 212 without having to detach the cameras 250 and 252 from corresponding modular puck upper portions 214 and 224. The modular puck lower portions 212 and 213 can serve as a common platform and can be used in combination with different modular puck upper portions.

Modular puck lower portions 212 and 213 rests on the base assemblies 204 and 205, respectively, when the puck assemblies 202 and 203 are in the rest positions shown in FIG. 2A. As shown in FIG. 2B, modular puck lower portions 212 and 213 connect with tethers 110 and 111 of the base assemblies 204 and 205. In other implementations, the tethers 110 and 111 may be omitted. The puck assemblies 202 and 203 and base assemblies 204 and 205 have the same capabilities as the puck assembly 102 and base assembly 104 described above with reference to FIGS. 1A-1C. For example, the puck assembly 202 can be lifted from base assembly 204 to permit a customer to interact with and inspect the camera 250.

The modulator puck upper portion 214 is configured as a mount for camera 250. As shown in FIG. 2B, the modulator puck upper portion 214 has an upper surface 244 on which the camera 250 is mounted as shown in FIG. 2A. The modulator puck upper portion 214 can be for use with the camera 250 that is capable of being charged via a standardized power cable 206 connected to a standardized connector located in the modular puck lower portion 212 and a standardized connector on the camera 250. For example, the power cable 206 may be a USB-compliant cable (e.g., a USB-C cable) that provides standardized connectivity with standardized ports on the camera 250 and a USB port 502 in the modular puck lower portion 212. Because the camera 250 can be charged from the modular puck lower portion 212, the modular puck upper portion 214 may be a purely mechanical component that mounts the camera 250 to the modular puck lower portion 212.

The modular puck upper portion 224 is configured as a mount for a camera 252. As shown in FIG. 2B. the modular puck upper portion 224 has an upper surface 246 on which the camera 252 can be mounted. The modular puck upper portion 224 may be used with a camera 252 that is not capable of being charged via a standardized power cable that connects to a standardized connector on the camera 252. The modular puck upper portion 224 can house one or more batteries that are used to provide operating electrical power for the camera 252 and are charged via contacts 506 located in the modular puck lower portion 213. The modular puck upper portion 224 may be referred to as a battery pack camera mount.

The same base assembly 204 and modular puck lower portion 212 that is used to merchandise camera 250 can also be used to merchandise camera 252 by swapping the modular puck upper portion 214 for the modular puck upper portion 224. For example, when the product merchandising systems 200 and 201 are disarmed, the modular puck upper portion 214 with attached camera 250 can be detached from the modular puck lower portion 212 and the modular puck upper portion 224 with attached camera 252 can be detached from the modular puck lower portion 213. The modular puck upper portion 214 with attached camera 250 may be attached to the modular puck lower portion 213 and the modular puck upper portion 224 with attached camera 252 may be attached to the modular puck lower portion 212.

FIG. 2A shows examples where the modular puck upper portion 214 is used to merchandise camera 250 and modular puck upper portion 224 is used to merchandise camera 252. Alternatively, camera 250 may be merchandised using the modular puck upper portion 224 and/or camera 252 may be merchandised using the modular puck upper portion 214. If modular puck upper portion 214 is used with camera 252, a user can keep a normal battery in the battery compartment of camera 252 rather than using the battery eliminator 230. If the camera 252 includes a connector that supports a data readout via power cable 206 (even if the camera 252 is unable to charge its on-board battery from that connector), a user may want to use power cable 206 to gather data about camera 252. If modular puck upper portion 224 is used with camera 250, a battery eliminator 230 can be used in place of the normal battery for camera 250. Also, a user may choose to connect power cable 206 to camera 252 even if the modular puck upper portion 224 is used to merchandise camera 252. The cable 206 may be used for data gathering from camera 252 in this scenario.

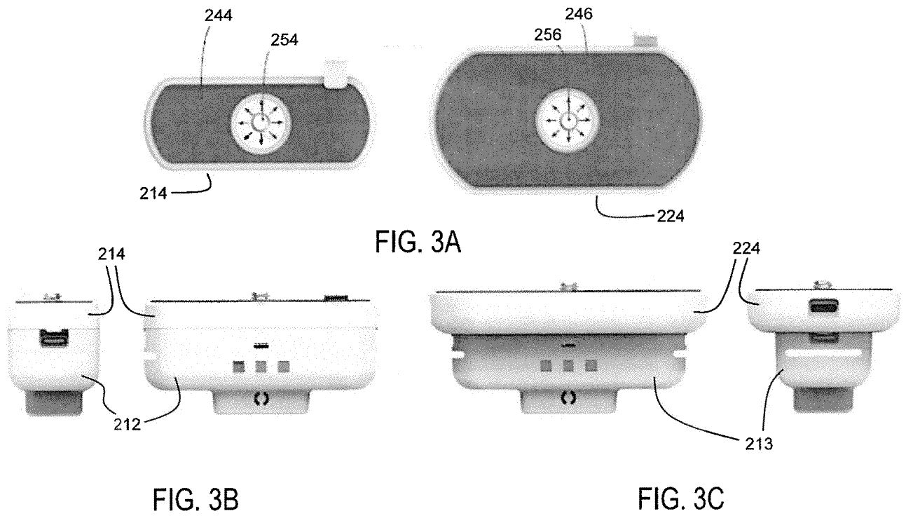

FIG. 3A shows top views of the modular puck upper portions 214 and 224. FIG. 3B shows two side elevation views of the modular puck upper portion 214 attached to the modular puck lower portion 212. FIG. 3C shows two side elevation views of the modular puck upper portion 224 attached to the modular puck lower portion 213. As shown in FIG. 3A (and FIG. 2B), modular puck upper portion 214 has a smaller upper surface 244 than the upper surface 246 of the modular puck upper portion 224 in order to provide suitable platforms dimensioned to support the differently sized cameras 250 and 252, respectively. Also, top/upper surfaces 244, 246 include a rubber, non-slip layer to facilitate mounting of cameras 250, 252. As shown in FIGS. 3A and 2B, the modular puck upper portions 214 and 224 include threaded fasteners 254 and 256, respectively. The fasteners 254 and 256 extend upward above the surfaces 244 and 246 of the modular puck upper portions 214 and 224 for attachment to corresponding threaded openings of the cameras 250 and 254, respectively.

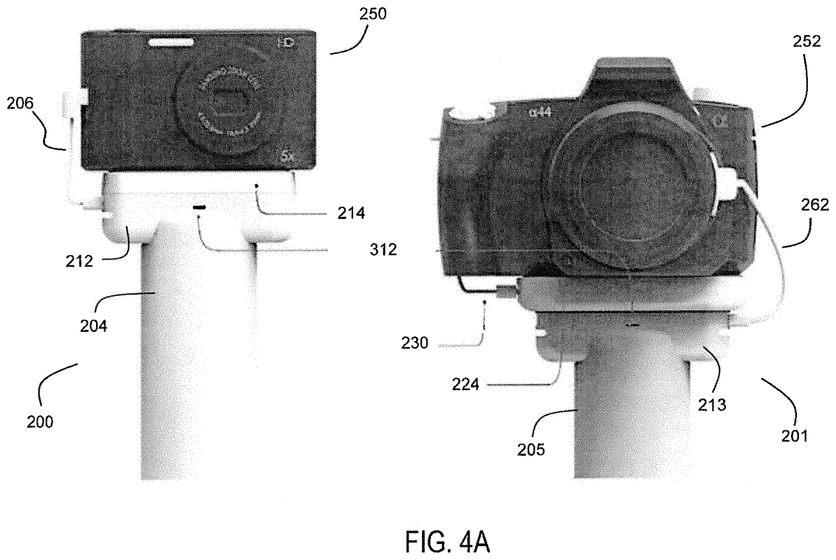

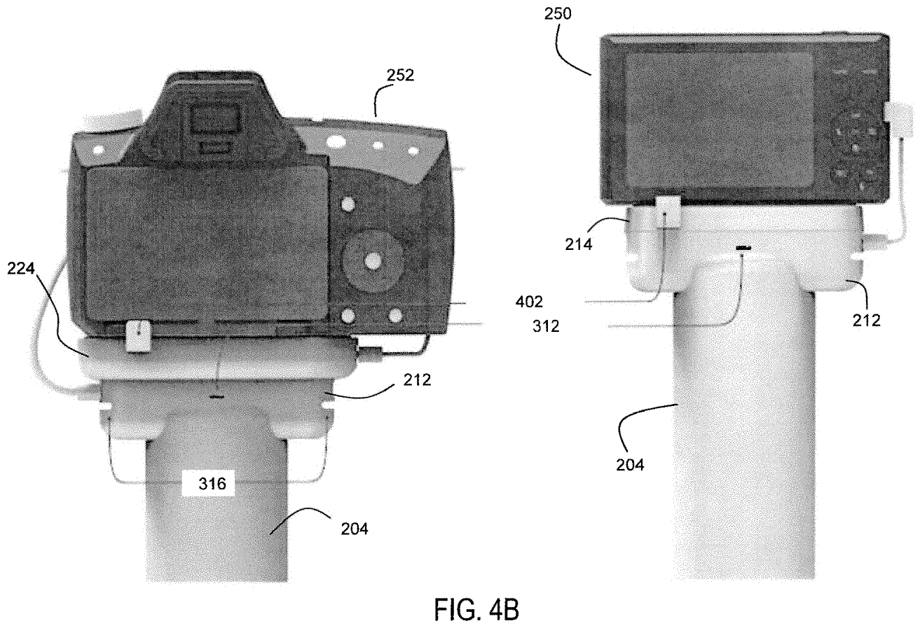

FIG. 4A shows front views of the product merchandising system 200 and the product merchandising system 201 with cameras 250 and 252 attached to the modular puck upper portions 214 and 224, respectively. FIG. 4B shows back views of the product merchandising system 200 and the product merchandising system 201 with cameras 250 and 252 attached to the modular puck upper portions 214 and 224, respectively. Back views the modular puck upper portions have clips 502 that engaged the back of the cameras 250 and 252 to prevent the cameras 250 and 252 from rotating with respect to the modular puck upper portions 250 and 252. As shown in FIGS. 4A and 4B, the base assembly 204 is taller than the base assembly 205, either of which can be used to display the cameras 250 and 252 heights. In other implementations, the base assemblies may have the same height.

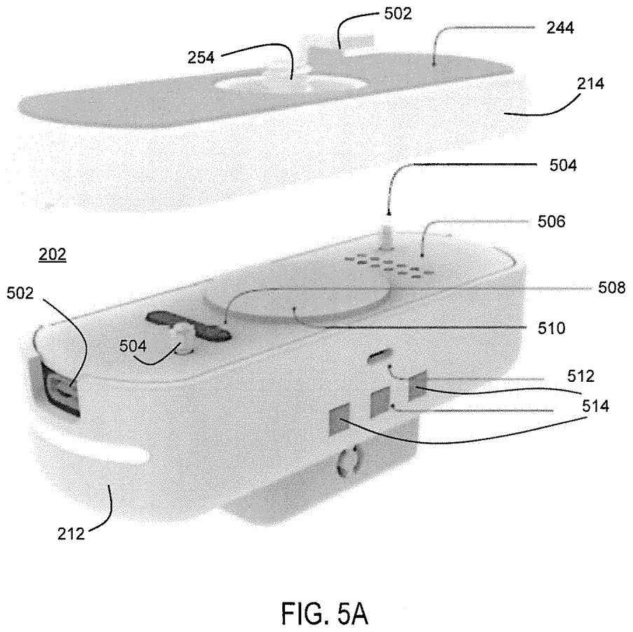

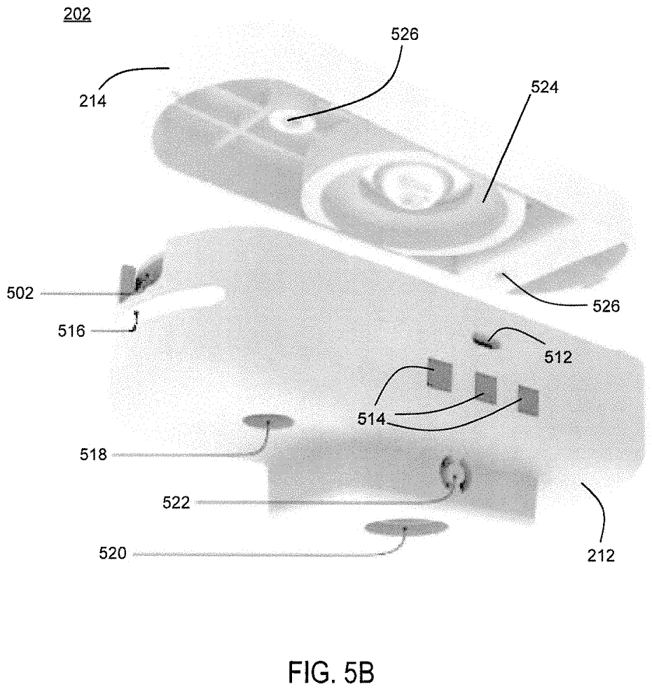

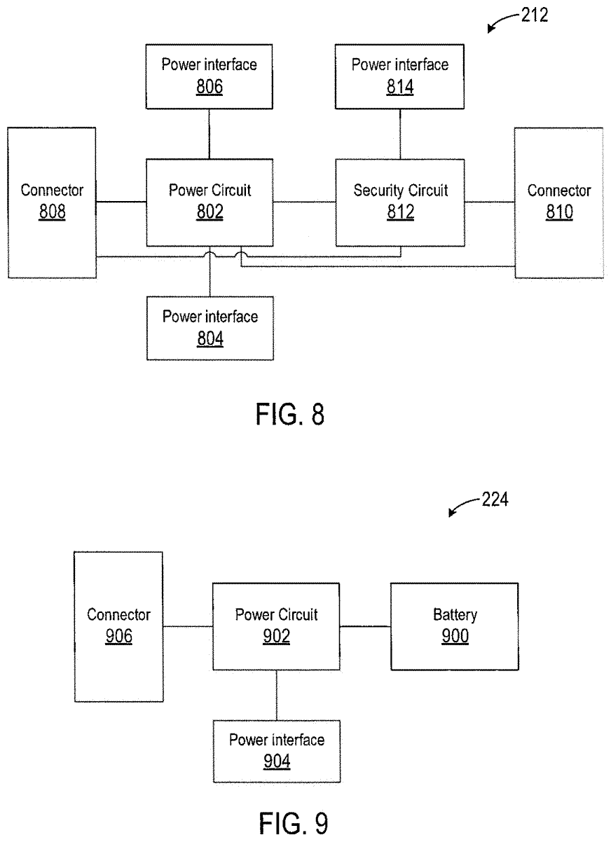

FIGS. 5A-5B show perspective views of the puck assembly 202 of FIGS. 2A and 2B with the modular puck upper portion 214 detached from the modular puck lower portion 212. Note that the modular puck lower portion 212 is also representative of the modular puck lower portion 213, which is identical to the modular puck lower portion 212. The modular puck lower portion 212 includes one or more attachment components that provide a detachable connection with the modular puck upper portion 214. In the example of FIG. 5A, the attachment component 504 is a threaded screw that extends upward from a top surface of the modular puck lower portion 212. The attachment component 504 attaches the modular puck upper portion 214 to the modular puck lower portion 212. In another implementation, the attachment component 504 could be a lock mechanism that engages with a lock mechanism on the modular puck upper portion. The top surface of the modular puck lower portion 212 includes a disk-shaped protuberance 510 that facilitates alignment of the modular puck lower portion 212 and the modular puck upper portion when the two are attached together. The example of FIG. 5A shows the disk-shaped raised surface 510 as a raised circular disk that mates with a corresponding disk-shaped recess 524 on the bottom of the modular puck upper portion 214 as shown in FIG. 5B. The modular puck lower portion 214 includes an alarm plunger 508 that is activated and activates an alarm located within the modular puck lower portion 214 if the modular puck upper portion 214 is removed without first turning of off the alarm as described below with reference to FIG. 8. The alarm sound is emitted through aperture 512. In an alternative implementation, the modular puck lower portion 212 has a disk-shaped recess and the modular puck upper portion 214 has a corresponding disk-shape raised surface that fits within the disk-shaped recess. In other implementations, the protuberance and corresponding recess may have different geometrical shapes, such as square, rectangle, or a hexagon.

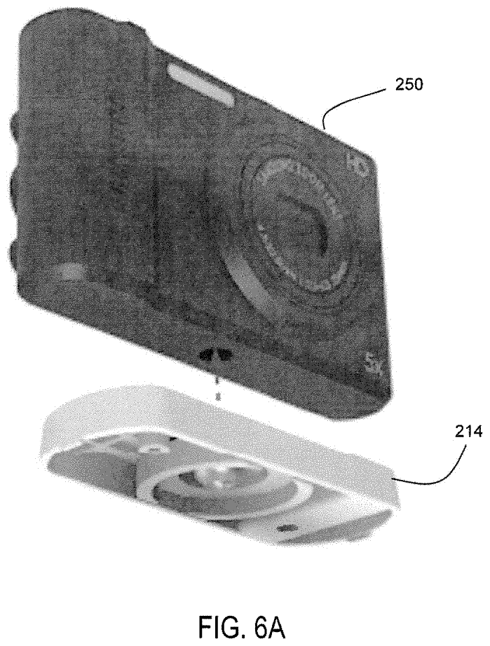

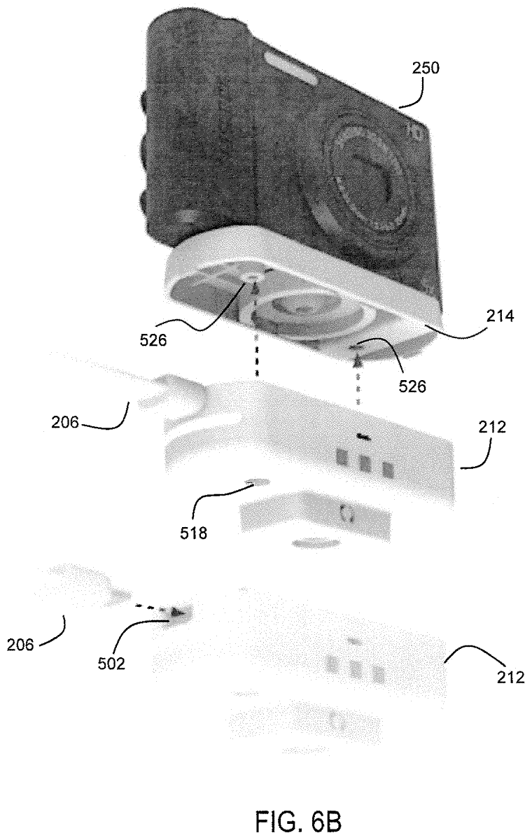

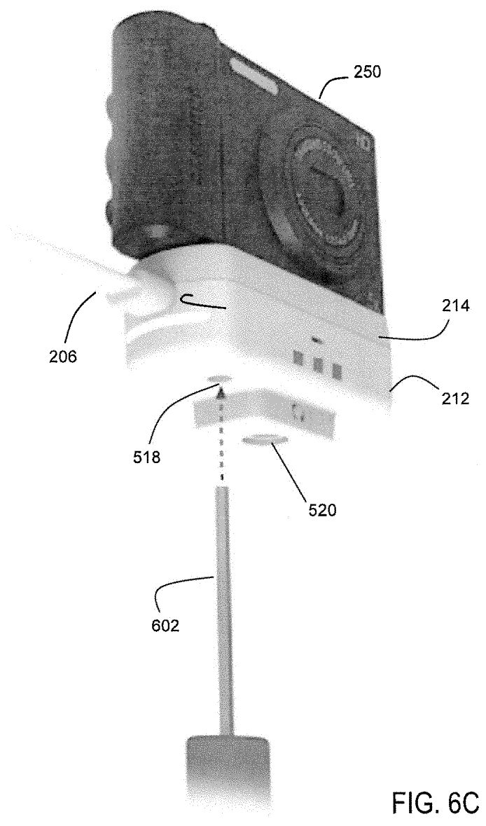

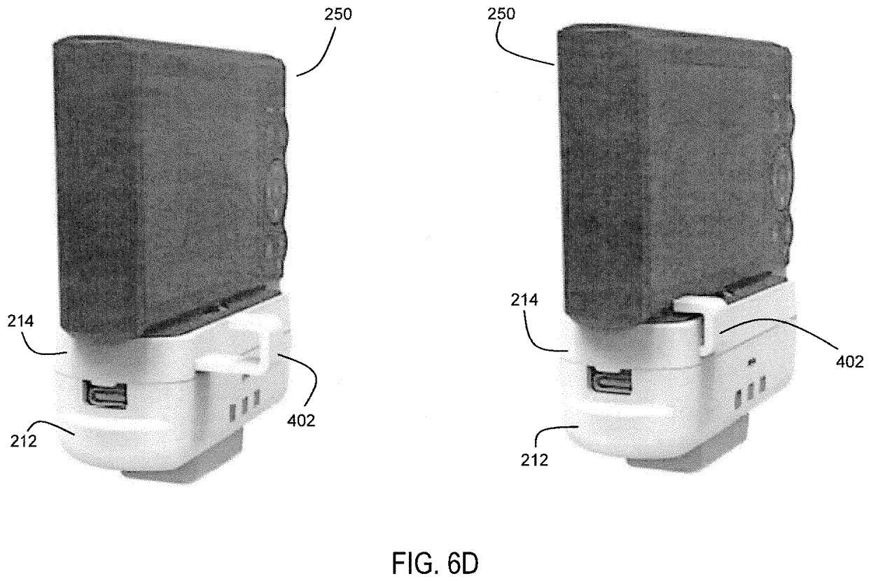

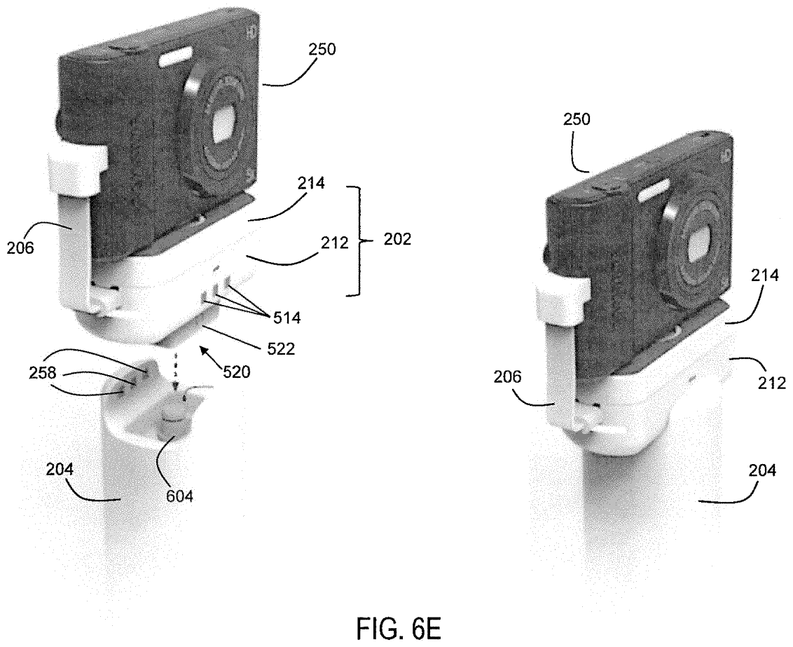

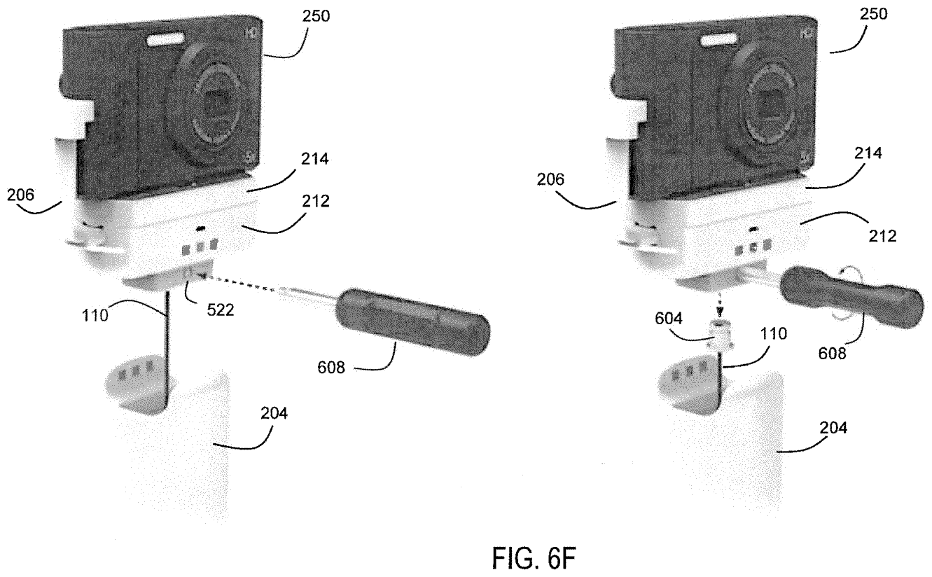

FIG. 5B shows a perspective view of the underside of the modular puck lower portion 212 and the modular puck upper portion 214 shown in FIG. 5A. This view reveals an opening 518 for inserting the attachment component 504 and reveals a tether aperture 520 for receiving an end of the tether 110 as described below with reference to FIG. 6E. Housed within the modular puck lower portion 212 can be a lock that releasably engages with the end of the tether 110 that gets inserted into the tether aperture 520. A tether connector such as a ferrule is attached to the end of the tether 110 that gets inserted into the tether aperture 520 for releasable engagement with the lock (e.g., see ferrule 604 of FIG. 6F). An example of a lock that can be used in this regard to collar the ferrule 604 at the end of tether 110 is described U.S. application Ser. No. 17/092,804, filed Nov. 9, 2020, and entitled “Product Merchandising System with Enhanced Security Features,” which is incorporated herein by reference. A lock interface 522 included on the lower portion of modular puck lower portion 212 for receiving a tool that locks and unlocks the tether 110 (e.g., see FIG. 6F). FIG. 5B also reveals the disk-shaped recess 524 for receiving the disk-shaped raised surface 510 in FIG. 5A.

The perspective views in FIGS. 5A and 5B also shows the modular puck upper portion 214 includes two attachment mechanisms 526 for receiving the two attachment mechanisms 504 for forming a detachable connection with the modular puck lower portion 212. For example, the attachment mechanisms 526 may be threaded recesses for receiving threaded fasteners 504. The modular puck upper portion 214 includes an anti-rotation mechanism 402 as discussed above with reference to FIG. 4B and below with reference to FIG. 6D. The modular puck lower portion 212 includes a USB port 502 and an LED indicator 516. The modular puck lower portion 212 also includes charge contacts 514 located on both sides of the modular puck lower portion 212 are aligned with charge contacts 258 located in the base assemblies 204 and 205. The charge contacts 514 and 258 enable transmission of electrical power from the base assembly 204 to the modular puck lower portion 212. The electrical power can be transmitted to the USB port 502 or to the charge contacts 506 that charge a battery located in the underside of the modular puck upper portion 214.

FIGS. 6A-6F show an example sequence of steps for merchandising camera 250 via the product merchandising system 200. As a first step, the camera 250 is mounted onto the top surface 244 of the modular puck upper portion 214 as shown in FIG. 6A. This can be accomplished by threading the fastener 254 into a threaded opening located in the base of camera 250. Next, as shown in FIG. 6B, the modular puck upper portion 214 (with mounted camera 250) is aligned with the modular puck lower portion 212 so that the opening 518 is aligned with the attachment mechanism 526. The modular puck upper portion 214 is attached to the modular puck lower portion 212 by inserting threaded screws 504 through openings 518 and into the threaded openings in the attachment mechanisms 526. As shown in FIG. 6C, a tool 602 (e.g., a screwdriver) is used tighten the threaded screws 504 into the threaded openings of the attachment mechanism 526 to create a detachable connection between the modular puck upper portion 214 and the modular puck lower portion 212. Next, power cable 206 can be plugged into connector 502 (i.e., USB port) of the modular puck lower portion 212 as shown by FIG. 6B.

As shown in FIG. 6D, when the camera 250 is mounted onto the modular puck upper portion 214, the anti-rotation mechanism 402 shown in FIG. 4B can be adjusted to prevent the camera 250 from being rotated as shown by FIG. 6D. The anti-rotation mechanism 402 prevents counter-rotation of the camera 250 off modular puck upper portion 214. The anti-rotation mechanism 402 can take the form of an arm with a U-shaped element as shown by FIG. 6D. The inner portion of mechanism 402 can be shaped to permit one-way insertion into the modular puck upper portion 214 when the modular puck upper portion 214 is connected to the modular puck lower portion 212. Once the arm 402 has been inserted to the point where the U-shaped end fits against the camera 250 to block counter-rotation, the modular puck upper portion 214, the modular puck lower portion 212, and the anti-rotation mechanism 402 cooperate to resist any further extension of the anti-rotation mechanism 402 away from the camera 250. For example, the anti-rotation mechanism 502 can fit within a compartment of the camera mount 214 that gets compressed when the camera mount 214 is connected to the modular puck lower portion 212. Furthermore, the inner portion of anti-rotation mechanism 402 can include ridges that are shaped to resist extension of the anti-rotation mechanism 402 out of the compartment when the compartment is compressed while permitting further insertion of the anti-rotation mechanism 502 up to the point where the anti-rotation mechanism abuts the camera 250. This one-way adjustability feature can be accomplished via ridges on anti-rotation mechanism 402 that are shaped with a sloped surface facing the modulator puck upper portion 214 while the ridge surfaces that face away from the modulator puck upper portion 214 are perpendicular. The sloped surface on the ridges are sufficient to permit anti-rotation mechanism 402 to slide inward if a pushing force is applied to the anti-rotation mechanism 402 even when the modulator puck upper portion 214 is connected to the modular puck lower portion 214. while the more upright opposite ridge surface will block extension of the anti-rotation mechanism 402 in the other direction when pulling forces are applied to the anti-rotation mechanism 402 when the modulator puck upper portion 214 is connected to the modular puck lower portion 212.

Next, as shown in FIG. 6E, the puck assembly 202 is connected to the tether 110 aligning the lock aperture 520 of the modular puck lower portion 212 with a tether connector 604 (e.g., a ferrule) at the end of tether 110 retracted inside the base assembly 204. The lock within the modular puck lower portion 212 can be engage through the lock interface 522 using a tool 608 shown in FIG. 6F to lock the tether connector 604 of the tether 110 to the puck assembly 202. At this point, the puck assembly 202 can be seated on the base assembly 204 in the rest position and the camera 250 is ready for merchandising as shown in FIG. 6E. When the puck assembly 202 is in rest position, charge contacts 258 located in the base assembly 204 contact charge contact 514 located on the modular puck lower portion 212.

FIG. 6F shows detaching the puck assembly 202 from the tether connector 604 using the tool 608. The tool 608 is inserted into the lock interface 522 to unlock the puck assembly 202 from the tether 110. For example, tool 608 can be used to apply a rotational force to the lock interface 522, which causes the lock to disengage from, or engage with, the tether connector 604. Once the puck assembly 202 is disengaged in this fashion, the camera 250 and mounted puck assembly 202 can be separated from the base assembly 204.

Wireless spatial sensing and alarming technology can be used to monitor whether the camera 250 and the attached puck assembly 202 has been moved far enough away from the base 204 to trigger an alarm or other warning to store personnel. Examples of such spatial sending and alarming technology are described in U.S. Publication No. 2018/0049563 and U.S. application Ser. No. 17/095,223, filed Nov. 11, 2020, and entitled “Systems and Methods for Spatial Sensing and Tracking of Objects in a Space,” which are incorporated herein by reference.

While the example of FIG. 6F shows that the puck assembly 202 is released from the tether 110 in response to operation of the tool 608, additional or alternate techniques for disconnecting the puck assembly 202 from the tether 110 may be used. For example, a wireless transceiver can be included in the modular puck lower portion 212, and this wireless transceiver can provide wireless connectivity with a remote computer that is capable of providing a wireless lock/unlock command for controlling the state of the lock that secures the puck assembly 202 onto tether 110.

While FIGS. 6A-6F show how camera 250 can be attached to the product merchandising system 200, a similar process can be used to attach camera 252 to the product merchandising system 201. For example, the same series of steps can be performed, with the exception of plugging the power cable into connector 502 of the modular puck lower portion 212 is replaced with a step of plugging battery eliminator 230 into connector port 248 of the modular puck upper portion 224. Also, the step of plugging in power cable 206 and/or battery eliminator 230 need not be performed as an actual second step of the sequence. This may be performed before or after the other steps of FIGS. 6A-6F.

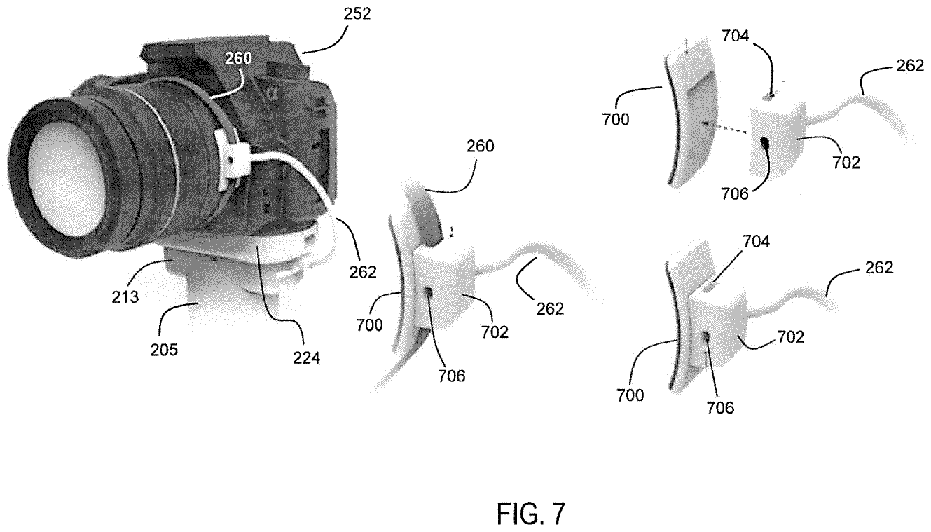

FIG. 7 shows a secondary security cable 262 used to secure an auxiliary component of a product to the modular puck lower portion 213. For example, the camera 252 has a lens that can be separately secured to the modular puck lower portion 213. The secondary security cable 262 includes a sensor 702 at an end portion near the lens (while the opposite end of the security cable 262 can be a standardized connector that inserts into the connector 502 of the modular puck lower portion 213 (see FIGS. 5A and 5B). The sensor 702 attaches to an auxiliary device mount 260 for the lens, where the auxiliary device mount 260 can be a metal or plastic strap that snugly fits around the diameter of the lens, as shown by FIG. 7. The auxiliary device mount 260 can be inserted through aperture 704 to mate the auxiliary device mount 260 with the sensor 702, for example, in a zip-tie arrangement. Sensor 702 can be powered with power from the modular puck lower portion 213 and detect whether auxiliary device mount 260 has become disconnected from the sensor 702. If so, the cable 262 sends a signal generated by the sensor 702 of an alarm condition to a security circuit (described below) located within the modular puck lower portion 213. A flexible mount 700 can also be used in concert with the loop 260 to engage with the lens of the camera 252. For example, the mount 700 may have an adhesive such as VHB for securing the mount 700 to the lens. The sensor 702 can also detect whether the mount 700 has become disconnected, whereupon the sensor 702 sends a signal to the security circuit (described below) located within the modular puck lower portion 213 that triggers an alarm signal. The sensor 702 can further provide a locking connection to the loop 260 and/or mount 700, where interaction with a tool at interface 706 releases the sensor 702 from the loop 260 and/or mount 700.

FIG. 8 shows an example architecture of electrical components of the modular puck lower portion 212. As shown by FIG. 8, the modular puck lower portion 212 include a power circuit 802 that provisions power from an external source for output via a connector 808. The connector 808 can be a standardized connection port such as a USB port (e.g., see USB port 502 of FIG. 5A). The modular puck lower portion 212 includes a power interface 804 through which it receives power from an external source. Power interface 804 may take the form of a plurality of conductive charge contacts, such as charge contacts 514 in FIGS. 5A and 5B, that contact corresponding conductive charge contacts 258 of the base assembly 204 when the puck assembly 202 is in the rest position on base assembly 204, as shown in FIGS. 2A, 4B, and 6E. In other implementations, the power interface 804 may be an inductive power interface that comprises one or more inductive coils that inductively couple with one or more corresponding inductive coils in the base assembly when the puck assembly 202 is in the rest position on base assembly 204. Power circuit 802 may also include a battery that is charged with power received from power interface 804 so that modular puck lower portion 212 can draw operational power from the battery when the puck assembly 202 is in the lift position.

The modular puck lower portion 212 includes a power interface 806 for providing power to a modular puck upper portion that has been detachably connected to the modular puck lower portion 212. Power interface 806 may be a plurality of conductive charge contacts, such as charge contacts 506 in FIG. 5A, that contact corresponding conductive charge contacts of the modular puck upper portion when the modular puck upper portion is attached to the modular puck lower portion 212. In other implementations, the power interface 806 may be an inductive power interface that comprises one or more inductive coils that inductively couple with one or more corresponding inductive coils in the modular puck upper portion when the modular puck lower portion 212 is attached to the modular puck upper portion. In still other implementation, power interface 806 may be omitted.

The modular puck lower portion 212 include a security circuit 812 that provides one or more security functions for the product merchandising system. For example, the security circuit 812 can work in conjunction with security sensor 814 to trigger an alarm signal in response to one or more security conditions being detected. For example, an unauthorized removal of a product from the puck assembly 202 can trigger an alarm signal. Security sensor 814 may take the form of a plunger pin that detects whether a product is present on the modular puck upper portion. With the modular puck assembly 202 described herein, a plunger pin could extend from the modular puck lower portion up through a recess of the modular puck upper portion to reach the product when the product is mounted on the modular puck upper portion. Thus, when a product is mounted on the modular puck upper portion, the plunger pin would be depressed and the security circuit 812 would register that a product is mounted by the puck assembly 202. If the product is removed from the modular puck upper portion, the plunger pin is released and the security circuit 812 generates an alarm signal if the security circuit was armed at the time. The security sensor 814 may also include a secondary plunger pin or the like that detects whether the modular puck upper portion is connected to the modular puck lower portion 212 (e.g., see plunger 508 of FIG. 5A). In this way, the security circuit 812 can also detect whether modular puck upper portion has been detached from the modular puck lower portion 212 and trigger an alarm signal if appropriate. The security circuit 812 may also detect whether cables have been removed from connector 808 and/or connector 810 and trigger an alarm signal if the cable removal occurred while the security circuit 812 is in an armed state. The security circuit 812 may also include an alarm that produces an audible, visual, and/or haptic alarm in the event an alarm signal is triggered. As shown by FIG. 5A, an aperture 512 provides a passage for alarm sounds so that any audible alarm signals produced by the security circuit 812 can be heard by nearby people. Security circuit 812 can be powered with power provided by power circuit 802.

The modular puck lower portion 212 can also include a connector 810 that serves as an auxiliary security port for securing one or more auxiliary components relating to the product to be merchandised. For example, as shown in FIGS. 7 and 2B, the camera 252 include a lens that is separately secured with a secondary security cable connected to connector 810 while the other end is secured to the lens as shown in FIG. 7. The security circuit 812 can detect whether the security cable 262 has been disconnected from connector 810 and trigger an alarm signal.

The modular puck lower portion 212 may include additional electronic components not shown by FIG. 8. For example, the modular puck lower portion 212 may include a wireless transceiver that provides wireless connectivity with a remote computer system via a wireless network (e.g., a wireless mesh network) as described in U.S. Publication No. 2018/0288720, which is hereby incorporated by reference. Through such a wireless transceiver, processing logic in the modular puck lower portion can interact with the remote computer system so that the remote computer system can wirelessly and remotely monitor and/or control the product merchandising system 200. For example, power cable 206 may include one or more data lines through which camera data can be communicated to a processor within the modular puck lower portion 212 to determine an identifier for the product merchandised via the product merchandising system 200. This information can then be passed to the remote computer system via the wireless transceiver. As another example, the modular puck lower portion 212 may include one or more visual indicators such as one or more light emitting diodes (LEDs) whose illumination is controlled to show an alarm status (e.g., flashing red light) and/or operational status for the product merchandising system 200 (e.g., see LED indicator 516 of FIG. 5B).

FIG. 9 shows an example of electrical components that can be included within a housing of the modular battery pack of the modular puck upper portion 224. The modular puck upper portion 224 may include a compartment for one or more batteries 900. The compartment may be opened/closed so that the battery 900 can be changed if desired. The size and number of batteries 900 may depend on the camera 252. For example, the battery may be a single cell battery or a double cell battery. The modular puck upper portion 224 may be configured to accommodate different batteries 900 that are used by different cameras. The modular puck upper portion 224 may also include a power circuit 902 that provisions power from the battery 900 to a connector 906 for delivery to the camera 252 via battery eliminator 230 shown in FIG. 2B. The battery eliminator 230 may be a power cable that includes a battery at one end for insertion into the battery compartment of the camera 252 and a standardized connector (e.g., a USB connector such as a USB-C connector) at the other end for detachable connection with connector 906 (e.g., see connector port 248 for camera mount 224 shown by FIG. 2B). The battery includes conductive terminals for the power cable that emulate the plus or minus terminals of a battery, thereby emulating the presence of a battery in the battery compartment of the camera 252. Thus, the camera 252 can draw power from the battery 900 of from the modular puck upper portion 224 via power circuit 902, connector 906, and battery eliminator 230.

The modular puck lower portion 212 can also include a power interface 904 that receives receiver power from the modular puck lower portion 212. In this implementation, the power circuit 902 can recharge battery 900 as needed. Power interface 904 may be a plurality of conductive charge contacts that will contact corresponding conductive charge contacts, such as charge contacts 506 in FIG. 5A, of the modular puck lower portion 212 when the modular puck upper portion 224 is detachably connected to the modular puck lower portion 212. In certain implementations, the power interface 904 may be an inductive power interface that comprises one or more inductive coils that will inductively couple with one or more corresponding inductive coils in the modular puck lower portion 212 when the modular puck upper portion 224 is detachably connected with the modular puck lower portion 212.

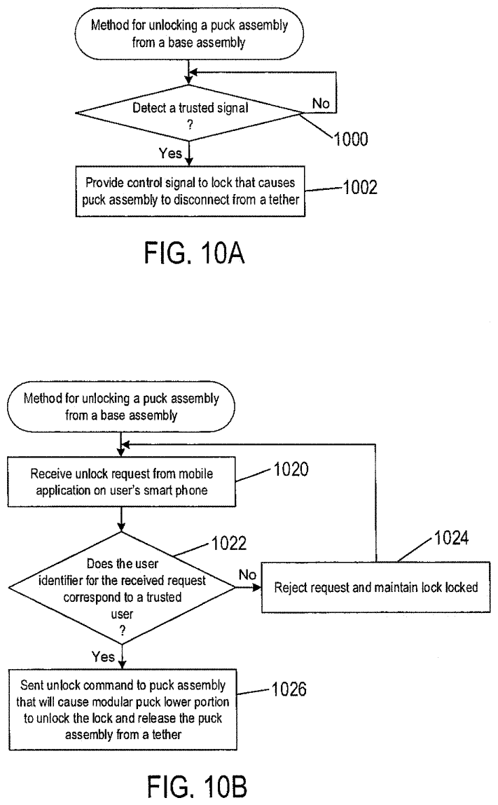

FIG. 10A is a flow diagram of a method for unlocking a puck assembly from a tether of a base assembly. In decision block 1000, when a trusted control signal for unlocking a lock located in the modular puck lower portion 212 is detected by a sensor in the modular puck lower portion 212, control flows to block 1002. In block 1002, a control signal is sent to the lock that causes the lock to open and the puck assembly can be removed from the tether. The operation represented by decision block 1000 can be performed by retail store personnel who enter an unlock command on a tablet computer that is part of a wireless network, which causes a remote computer system (such as that described by the above-referenced and incorporated U.S. Publication No. 2018/0288720) to transmit a wireless unlock command to the modular puck lower portion 212 of the subject product merchandising system 200. In an alternative implementation, step 1000 may be performed in an automated manner using a mobile device such as a smart phone.

FIG. 10B is a flow diagram of a method for unlocking a puck assembly from a tether of a base assembly. For example, a user can load a mobile application onto a smart phone that registers the user with a retail store or other authority to establish a trusted user. The mobile application can be embodied by a plurality of instructions for execution by a mobile device (e.g., smart phone) and that are resident on a non-transitory computer-readable storage medium such as computer memory. When the user approaches the product merchandising system 200 with a merchandised product (e.g., camera 250 or 252), in block 1020, the user can use the mobile application to send an unlock request to a remote computer system via a wireless network. This request identifies the user and the product (or retail security position where the product is being merchandised). For example, the mobile application can take a picture of machine-readable indicia on the product merchandising system 200 such as a QR code or bar code. This request can be sent by the mobile application to the remote computer system for reception thereby (see block 1020 of FIG. 10B). The remote computer system can maintain a data structure that tracks which products are being merchandised at which product merchandising systems using the technology described in U.S. Publication No. 2018/0288720. In block 1022, the remote computer system can also maintain a database of trusted users and is consulted to find if there is a trusted user corresponding to the user identifier in the received request. If the user is not a trusted user, the process flows to block 1024 where no control signal is provided to unlock the lock and the product remains tethered to the product merchandising system 200. If the user is found to be trusted at step 1022, the process flows to block 1026 where an unlock command is sent to the puck assembly that will cause the modular puck lower portion to unlock the lock and release the puck assembly from a tether. In another implementation, in block 1022, a secondary set of checks may be executed to ensure that the user's smart phone is physically present near the product merchandising system 200. Location tracking of the customer's smart phone via GPS or other position detection techniques can be used to support this secondary check (where the mobile application can then be configured to share position information with the remote computer system as part of the unlock request).

In block 1026, the remote computer system can access product tracking data structure to identify the product merchandising system 200 to which the request is applicable. This can allow the remote computer system to address an unlock command to the subject product merchandising system, and this unlock command can be wireless transmitted over the wireless network. The wireless transceiver in the subject modular puck lower portion 212 can then receive this unlock command and cause control logic in the modular puck lower portion to issue a control signal to the lock that changes the lock to an unlocked state the permits disconnection between the puck assembly 202 and the tether 110.

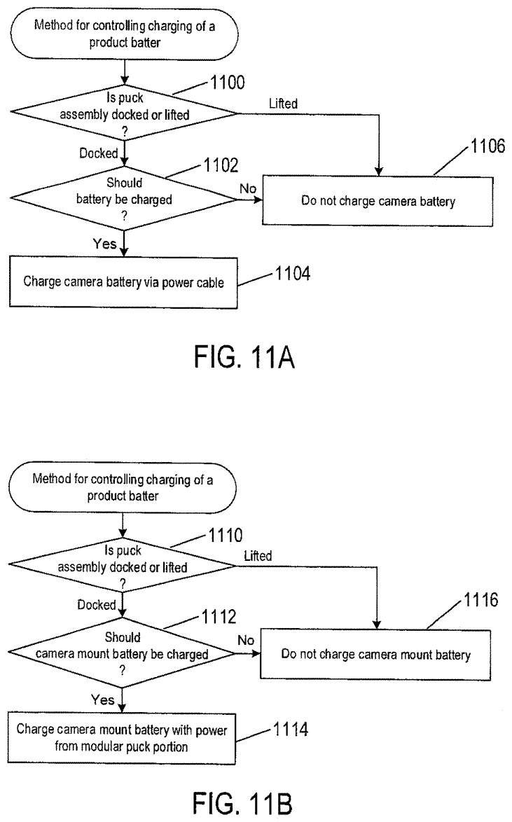

FIG. 11A is a flow diagram of a method for controlling charging of a battery of a product attached to a puck assembly as described above. The method is described with reference to camera 250 and onboard battery charging. In block 1100, a processor within the modular puck lower portion 212 determines whether the puck assembly 202 is in the lift position or in the rest (docked) position. Any of many techniques can be used to make this determination, such as monitoring whether an electrical connection exists between charge contacts 514 and 258 described above. If no connection between the contact, then the puck assembly 202 is in the lift position. If the puck assembly 202 is docked in a rest position on the base assembly 204, the power can be passed from the base assembly 204 to the power circuit 802 via power interface 804. In block 1102, the processor can then decide whether the power circuit 802 should draw from this power to charge the camera battery in camera 250 via connector 808 and power cable 206. In making this decision. the power circuit 802 can estimate a state of charge in the camera battery (or other battery characteristics such as battery temperature) by monitoring the electrical characteristics of the charge drawn by the camera 250. As another example. the power circuit 802 can directly monitor the state of charge in the camera battery (or other battery characteristics such as battery temperature) by receiving readings of the battery state that may be provided by the camera 250 through power cable 206. Some cameras 250 may be configured to not only communicate their camera identifiers through a data line of the power cable 206 but also status information about the camera 250, including current readings of battery characteristics. Based on the estimated or monitored battery characteristics, the power circuit 802 can decide whether to continue (or start) charging the camera battery in block 1102. For example, the power circuit 802 may decide to keep the battery charge in a range between 30% and 70% of its charge capacity. If the camera battery is to be charged, in block 1104, a power is sent the camera battery via connector 808 and power cable 206. If the camera battery is not to be charged, control flows to block 1106 where no power is not provided to the camera via connector 808 and power cable 206.

If the puck assembly 202 is not docked in a rest position on the base assembly 204 (i.e., the puck assembly 202 is in the lift position), power cannot be transferred from the base assembly 204 to the camera 250 because the connection with power interface 804 is broken. In this situation, control flows to block 1106 where no power provided to the battery of the camera 250.

When the puck assembly 202 is in the lift position or rest position, the camera 250 itself draws power from the on-board battery for operational power (e.g., to take any sample photographs that a customer may want to take to demo the camera 250).

FIG. 11B is a flow diagram of a method for controlling charging of a battery of product attached to a puck assembly as described above. The method is described with reference to charging the battery for camera 252. In block 1110, a processor within the modular puck lower portion 212 and/or camera mount 224 determines whether the puck assembly 202 is in the lift position or in the rest (docked) position. Any of many techniques can be used to make this determination, such as determining whether an electrical connection exists between charge contacts 514 and 258 as described above. If the puck assembly 202 is docked in a rest position on the base assembly 204, power can be passed from the base assembly 204 to the power circuit 802 of the modular puck lower portion via power interface 804. In block 1112, the processor can then decide whether the power circuit 802 should draw from this power to charge a battery 900 in the modular puck upper portion 224. If the processor is resident in the power circuit 802, the power can be passed from power interface 806 into power interface 904 and into power circuit 902 for delivery to the battery 900. If the processor is resident in power circuit 902, the processor can choose whether to provide power to battery 900 from power available from power interface 904. In making this decision, the processor can employ the any of the intelligent charging techniques described in U.S. Publication No. 2019/0288537. For example, the power circuit 802 and/or 902 can be configured to estimate a state of charge in battery 900 (or other battery characteristics such as battery temperature) by monitoring the electrical characteristics of the charge drawn by the battery 900. As another example, the power circuit 802 and/or power circuit 902 can directly monitor the state of charge in battery 900 (or other battery characteristics such as battery temperature) by receiving readings of the battery state. Based on the estimated or monitored battery characteristics, the power circuit 802 and/or power circuit 902 can decide whether to continue (or start) charging battery 900. For example, the processor can use such intelligence to keep the battery charge in a range between 30% and 70% of its charge capacity. If battery 900 is to be charged, control flows to step 1114 where power is delivered to the battery 900. If battery 900 is not to be charged, control flows to block 1126 where power not provided to battery 900.

If the puck assembly 202 is not docked in a rest position on the base assembly 204 (i.e., the puck assembly 202 is in the lift position), power cannot be transferred to the base assembly 204 because the connection with power interface 804 would be broken. In this situation, control flows to block 1116 where no charge signal is provided to battery 900.

Whether in the puck assembly 202 is in the lift position or rest position, the camera 252 itself can draw power from the battery 900 via battery eliminator 230 for operational power (e.g., to take any sample photographs that the customer may want to snap to demo the camera 252).

With either of the FIG. 11A or FIG. 11B process flows, the power circuit 802 can also employ similar intelligent battery management techniques as those discussed above for determining whether the battery in modular puck lower portion 212 needs to be further charged.

The power circuit 802 and/or power circuit 902 can employ battery isolation techniques as described in U.S. application Ser. No. 17/066,693, filed Oct. 9, 2020, and entitled “Systems and Methods for Electronically Disconnecting Batteries,” which is incorporated herein by reference. Thus, if the processing logic in power circuit 802 and/or power circuit 902 detects conditions that render it desirable to electronically disconnect battery 900 and/or the battery of modular puck lower portion 212 from their associated operational circuitry to avoid unnecessary charge leakage. For example, if the processing logic determines that the product merchandising system is not being used for an extended period, such as after being moved to storage or powered down overnight as evidenced by long periods where the product merchandising system 200 is unpowered, and/or if the processing logic receives a user command to enter a sleep mode or the like, switches can be opened that are effective to electronically disconnect battery 900 and/or the battery of modular puck lower portion 212 from their associated operational circuitry.

It is appreciated that the above description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system for merchandising products, the system comprising:
a puck assembly for mounting a product; and
a base assembly on which the puck assembly is restable,
wherein the puck assembly can be moved between a rest position on the base assembly and a lift position off the base assembly,
wherein the puck assembly includes a modular puck lower portion and a modular puck upper portion,
wherein the modular puck upper portion is detachably connectable to the modular puck lower portion,
wherein the modular puck lower portion includes a circuit that provides power for delivery to the product, and
wherein the modular puck upper portion includes a top surface for mounting the product.

2. The system of claim 1 wherein the modular puck lower portion includes a connector that is connectable to a power cable, the circuit provides power to the connector for delivery to the product via the power cable, and the power cable is detachably connectable to the connector and the product.

3. The system of claim 1 wherein the circuit stops delivering power to the product in response to the puck assembly being in the lift position.

4. The system of claim 1 wherein the circuit provides power to a rechargeable battery of the product, and wherein the circuit monitors and/or estimates one or more characteristics of the rechargeable battery to determine whether to provide a charge signal to the rechargeable battery.

5. The system of claim 1 wherein the circuit provides power to a rechargeable battery of the product, and wherein the circuit disconnects the rechargeable battery from the provided power in response to a predetermined criterion being satisfied.

6. The system of claim 1 wherein the modular puck upper portion comprises a battery, a connector, and a circuit that delivers power from the battery to the product via the connector, and wherein the connector of the modular puck upper portion is detachably connected with a battery eliminator.

7. The system of claim 6 wherein the battery comprises a rechargeable battery, and wherein the circuit of the modular puck lower portion and/or the circuit of the modular puck upper portion monitors and/or estimates one or more characteristics of the rechargeable battery to determine whether to provide a charge signal to the rechargeable battery.

8. The system of claim 6 wherein the battery comprises a rechargeable battery, and wherein the circuit of the modular puck lower portion and/or the circuit of the modular puck upper portion disconnects the rechargeable battery from circuitry in the modular puck upper portion in response to a predetermined criterion being satisfied.

9. The system of claim 1 wherein the modular puck lower portion comprises a power interface for receiving power from a power interface of the base assembly when the puck assembly is in the rest position.

10. The system of claim 1 wherein the modular puck lower portion comprises
a lock for releasably connecting the puck assembly to a tether of the base assembly; and
a wireless transceiver that receives a wireless unlock command from a remote source to control a state of the lock.

11. The system of claim 1 further comprising a mobile application for execution on a mobile device to establish a user as a trusted user to control transmission of a wireless lock/unlock command to a wireless transceiver located in the modular puck lower portion.

12. A system for merchandising products, the system comprising:
a puck assembly for mounting any of a plurality of different products; and
a base assembly on which the puck assembly is restable.
wherein the puck assembly can be moved between a rest position on the base assembly and a lift position off the base assembly, and
wherein the puck assembly includes a modular puck lower portion that is detachably connectable with a plurality of different types of modular puck upper portions for use with different types of products, the different types of modular puck upper portions including a first modular puck upper portion for use with a first type of product and a second modular puck upper portion for use with a second type of product.

13. The system of claim 12 wherein the modular puck lower portion includes a circuit that provides power for delivery to the product, and
wherein the modular puck upper portion includes a top surface for mounting the product.

14. The system of claim 12 wherein the modular puck lower portion includes a connector that is connectable to a power cable, the circuit provides power to the connector for delivery to the product via the power cable, and the power cable is detachably connectable to the connector and the product.

15. The system of claim 12 wherein the circuit stops delivering power to the product in response to the puck assembly being in the lift position.

16. The system of claim 12 wherein the circuit provides power to a rechargeable battery of the product, and wherein the circuit monitors and/or estimates one or more characteristics of the rechargeable battery to determine whether to provide a charge signal to the rechargeable battery.

17. The system of claim 12 wherein the circuit provides power to a rechargeable battery of the product, and wherein the circuit disconnects the rechargeable battery from the provided power in response to a predetermined criterion being satisfied.

18. The system of claim 12 wherein at least one of the first and second modular puck upper portions comprises a battery, a connector, and a circuit that delivers power from the battery to the product via the connector, and wherein the connector of the modular puck upper portion is detachably connected with a battery eliminator.

19. The system of claim 18 wherein the battery comprises a rechargeable battery, and wherein the circuit of the modular puck lower portion and/or the circuit of the modular puck upper portion monitors and/or estimates one or more characteristics of the rechargeable battery to determine whether to provide a charge signal to the rechargeable battery.

20. The system of claim 18 wherein the battery comprises a rechargeable battery, and wherein the circuit of the modular puck lower portion and/or the circuit of the modular puck upper portion disconnects the rechargeable battery from circuitry in the modular puck upper portion in response to a predetermined criterion being satisfied.

21. The system of claim 12 wherein the modular puck lower portion comprises a power interface for receiving power from a power interface of the base assembly when the puck assembly is in the rest position.
